(19) United States
(12) Patent Application Publication
(10) Pub. No.: US 2016/0107123 A1
(43) Pub. Date: Apr. 21, 2016

(54) PROCESS OF EXTRACTION OF PHYTOCHEMICALS FROM VEGETATION LIQUORS OF OIL-BEARING FRUITS

(71) Applicant: MALASIAN PALM OIL BOARD, Selangor Darul Ehsan (MY)

(72) Inventors: RAVIGADEVI SAMBANTHAMURTHI, Selangor Darul Ehsan (MY); Tan Yew Ai, Kuala Lumpur (MY); KALYANA SUNDRAM, Selangor Darul Ehsan (MY)

(73) Assignee: Malasian Palm Oil Board, Selangor Darul Ehsan (MY)

(21) Appl. No.: 14/894,978

(22) PCT Filed: May 27, 2014
(86) PCT No.: PCT/MY2014/000122

§ 371 Date: Nov. 30, 2015

(30) Foreign Application Priority Data
May 31, 2013 (MY) PI 2013001990

(51) Int. Cl. B01D 61/58; B01D 17/02; B01D 63/02; B01D 11/04

(52) U.S. Cl. CPC B01D 61/58; B01D 11/0415; B01D 17/0217; B01D 63/02; A23L 1/3002; A23V 2002/00

(57) ABSTRACT

A process for extraction of phytochemicals from vegetation liquor derived from oil-bearing fruit including: contacting the vegetation liquor with a material that preferentially adsorbs or absorbs oleaginous parts; filtering the vegetation liquor to yield an oleaginous retentate and a colloidal aqueous solution; and filtering the colloidal aqueous solution obtained from the vegetation liquor, with a hollow fibre filter, wherein the hollow fibre filter is configured to remove molecules above 10000 Daltons in molecular weight and allows molecules 10000 Daltons or less to pass through as aqueous permeate; wherein the aqueous permeate comprises phytochemical.

### CROSS REFERENCE TO RELATED APPLICATIONS

This application is a U.S. National Phase Under 37 C.F.R §371 of PCT Application Serial No. PCT/MY2014/000122, filed May 27, 2014, which claims priority to Malaysian Patent Application Serial No. PI 2013001990, filed May 31, 2013, each of which is incorporated herein by reference in its entirety.

### FIELD OF INVENTION

The present invention generally relates to vegetation liquors, more particularly to the improved method for treatment of vegetation liquors derived from oil-bearing fruit, for example from oil palm fruit, and to products therefrom.

### BACKGROUND OF THE INVENTION

Growing environmental consciousness has made it imperative to recycle and utilize waste. The wastes from plant material processing are often discarded causing pollution to waterways and water sources.

Oil palm fruit processing generates twice the tonnage of vegetation liquor as compared to crude palm oil production. Vegetation liquor is usually channeled to the waste stream as Palm Oil Mill Effluent (POME). Currently, there are few treatments and uses for vegetation liquors and palm oil mill effluent. Among them are either applying effluent, with or without treatment, onto the crop growing area, or reduction of chemical and biological oxygen demand before release of treated effluent into the environment, or generation of feed for livestock, or generation of substrates for the growth of microorganisms (“A novel treatment process for palm oil eluent”, Ma et al., PORIM Technology No. 19, October 1996).

The use of membrane filtration in the treatment of such effluents, whether in research or in practice, has hitherto been focused upon one or more of the above objectives rather than those aims which are the subject of this invention (“Palm oil mill effluent treatment by ultrafiltration: An economic analysis”, Mohd. Tusirin Nor et al, Second ASEAN Workshop on membrane technology, 1982). Despite the fact that the existing treatment as described in MY-134878-A have provided a solution to solve effluent problem, the treatment can still be further modified and improved to increase efficiency.

Furthermore, it has hitherto been accepted in palm oil mill practice that the recovery of any remaining oil from effluent is not carried out despite the presence in said effluent of nominally one to two percent oil content, often more in reality. Similarly, vegetation liquor has hitherto been ignored as potential source of water-soluble biologically active compounds including, but not limited to, flavonoids, phenolics and hydroxyl acids. Neither has the oil palm fruit been used as a source for such compounds nor as a source of a drink or tonic based upon its aqueous fraction.

The present invention has an object to provide improved treatments of vegetation liquors derived from oil-bearing fruit, for example from oil palm fruit, for higher efficiency and yield. A further object of the present invention is to find new uses for, and better utilise the content of, such vegetation liquors by recovering fractions containing valuable components including, but not limited to, flavonoids, phenolic acids and hydroxyl acids. Another object of this invention is to put waste streams from oil-bearing fruit processing plants to more useful ends. Yet another object of the invention is to realise new and/or improved products through the use of aqueous substances derived from oil-bearing fruit, including but not limited to drinks, edible products, tonics, health supplements, antioxidants additives, cosmetics, soaps, shampoos, detergents, drugs or medicinal compositions. Concomitantly, an object of the invention is to reduce pollution by making better treatment of waste streams from oil-bearing fruit processing plants.

### SUMMARY OF THE INVENTION

The present invention discloses an improved process for extraction of phytochemicals from vegetation liquor derived from oil-bearing fruit comprising filtering a colloidal aqueous solution obtained from said vegetation liquor with a hollow fibre filter, wherein said hollow fibre filter is configured to remove molecules above 10000 Daltons in molecular weight and allows molecules with 10000 Daltons or less molecular weight, to pass through. The hollow fibre filtration yields an aqueous permeate that includes phytochemicals. The colloidal aqueous solution is obtained from the vegetation liquor by pre-filtration method that includes contacting vegetation liquor with a material that preferentially adsorbs or absorbs substantially all oleaginous parts. This is followed by filtering said vegetation liquor with stainless steel strainer to yield an oleaginous retentate and the colloidal aqueous solution.

The process further comprising the step of obtaining an oleaginous fraction and a colloidal fraction by hollow fibre filtration for filtering vegetation liquor to yield an oleaginous retentate containing substantially all the oleaginous parts and substantially all the solids; followed by filtering the oleaginous retentate to remove substantially all solids, giving the oleaginous fraction as filtrate; wherein the retentate yielded by the hollow fibre filtration is a colloidal fraction containing substantially all colloidal particles and solutes, where substantially all of which molecules are above 10000 Daltons in molecular weight.

In one preferred embodiment, the process further comprising a brush filter to filter out big particles prior to the step of obtaining an oleaginous fraction and a colloidal fraction.

The process further comprising the step of obtaining an oleaginous fraction and a colloidal fraction by hollow fibre filtration for filtering vegetation liquor to remove substantially all solids, to yield an oleaginous fraction containing substantially all the oleaginous parts as retentate, and an aqueous substance containing substantially all the colloidal particles and substantially all the solutes as permeate; followed by filtering the aqueous substance to yield a colloidal fraction as retentate, the colloidal fraction containing substantially all colloidal particles and solutes, where substantially all of which molecules are above 10000 Daltons in molecular weight.

The vegetation liquor is derived from palm oil mill effluent, and the process further comprising removing water content from the aqueous fraction to give a concentrated aqueous fraction, or a residue. The vegetation liquor is derived from one or more sources selected from the group consisting of palm oil fruitlets, oil palm fruit bunch, hot sterilizer condensate collected immediately on discharge from the horizontal sterilizers at a palm oil mill, and discharge from the sludge centrifuge at a palm oil mill.

The aqueous permeate is substantially free of oleaginous parts, colloidal substances, and solids. The hollow fibre membrane filter is configured to remove molecules above 10000 Daltons in molecular weight.

The present invention also discloses an aqueous fraction containing phytochemicals obtained by the process stated above. The aqueous fraction might be concentrated by removing or reducing water content. A residue containing phytochemicals is produced by removing substantially all of the water content from the aqueous fraction obtained by the process of stated above.

Nonetheless, a process for extraction of phytochemicals from vegetation liquor derived from palm fruit is disclosed, where it comprises the steps of centrifuging the vegetation liquor to give a light phase, a sediment phase and an aqueous phase, recovering the aqueous phase; and filtering said aqueous phase with a hollow fibre filter, wherein said membrane filter is configured to remove molecules above 10000 Daltons in molecular weight; wherein the membrane filtration yields an aqueous permeate comprising phytochemicals. The centrifuging of vegetation liquor is conducted at such conditions in which the oil emulsion in water breaks and leads to better separation of oil as a layer. The conditions may be achieved by lowering temperatures. In one embodiment, the vegetation liquor is centrifuged at lower temperatures such as between 10° C. and 20° C.

A process for obtaining palm extract comprising hydroxy acids, phenolic acids or flavonoids from vegetation liquor derived from palm fruit, said process comprising filtering said vegetation liquor with a membrane filter, wherein said membrane filter is configured to remove molecules above 41,000 Daltons in molecular weight; adjusting the pH of the permeate to effect separation of hydroxy acids, phenolic acids or flavonoids or any combination thereof into either an aqueous phase or a solvent phase; and recovering the phase containing the hydroxy acids, phenolic acids or flavonoids or any combination thereof, thereby obtaining the extract. The aqueous fraction has been concentrated or reconstituted from a residue. An extract comprising hydroxy acids, shikimic acid, phenolic compounds including phenolic acids or flavonoids is obtained through the process of drying substantially all of the water or substantially all of the solvent.

### DETAILED DESCRIPTION OF THE PREFERRED EMBODIMENTS

In the following detailed description, numerous specific details are set forth in order to provide a thorough understanding of the invention. However, it will be understood by those of ordinary skill in the art that the invention may be practiced without these specific details. In other instances, well-known methods, procedures and/or components have not been described in detail so as not to obscure the invention. Reference will now be made in detail to the preferred embodiments of the present invention, examples of which are illustrated in the accompanying drawings.

The sources of vegetation liquors derived from oil-bearing fruit may be but not limited to oil-bearing fruit of any herbaceous or arboraceous plant or from a combination of such fruit, fruit of the oil palm plant, aqueous streams from oil mills that process oil-bearing fruit, palm oil mill effluent or concentrated palm oil mill effluent, steriliser condensate from a palm oil mill, waste from any oil clarification stage at a palm oil mill or any centrifuge stage at a palm oil mill or any oil trap at a palm oil mill.

The above list is not intended to exhaust the possible sources of vegetation liquors derived from oil-bearing fruit and any other such sources not named explicitly, for example, olive flume wastewater, are meant to be included as input material for the invention. It will be clear that the input material is not restricted to pure fruit but also includes any ancillary vegetative matter collaterally processed with the fruit.

This invention herein discloses a method of obtaining a drink or an edible product or a tonic or a health supplement or an antioxidant additive or a cosmetic or a soap or a shampoo or a detergent or a drug or a medicinal product, characterised in that an aqueous fraction separated from vegetation liquor derived from oil-bearing fruit, and said aqueous fraction having substantially no oleaginous parts nor colloidal particles nor undissolved solids, and said aqueous fraction comprising phytochemicals such as flavonoids, phenolic acids and hydroxyl acids, or a concentrate, a residue or an extract derived from said aqueous fraction, is combined in any way, form or proportion, to any other substance or substances.

According to this invention, a process is disclosed for extraction of phytochemicals from vegetation liquors derived from oil-bearing fruit characterised in that an aqueous fraction or a concentrated aqueous fraction or a residue containing phytochemicals is separated and recovered from vegetation liquor, separation being adapted to remove substantially all oleaginous parts, undissolved solids, colloidal particles and molecules above 10000 Daltons in molecular weight. In other words, meaning the aqueous fraction containing solute of which molecules are below 10000 Daltons in molecular weight is recovered, where some or substantially all of the water content of said aqueous fraction is removed to give concentrated aqueous fraction or residue.

Further according to the present invention, a process for extraction of phytochemicals from vegetation liquor derived from oil-bearing fruit comprises obtaining a colloidal fraction and an aqueous fraction by first contacting vegetation liquor with a material that preferentially adsorbs or absorbs substantially all the undissolved solids to give as filtrate and essentially colloidal aqueous substance. This is followed by separating the colloidal aqueous substance into two fractions by one or more stainless steel strainer. This yields retentate which is a colloidal fraction containing substantially all the colloidal particles and solutes of which molecules are above 10000 Daltons in molecular weight; and yields permeate having solutes substantially all of which molecules are below 10000 Daltons in molecular weight. Stainless steel strainer is more inert as compared to other metal strainer and it extends the lifespan of the filter system in separating substances into fractions.

In accordance to one's preferred embodiment, a decanter may be used for separating the suspended solids from crude palm oil in a clarification tank.

Also according to this invention, a process for extraction of phytochemicals from vegetation liquor derived from oil-bearing fruit comprises obtaining an oleaginous fraction, a colloidal fraction and an aqueous fraction from said vegetation liquor by the steps of centrifuging said vegetation liquor to give a light phase, being essentially all the oleaginous parts, said light phase being recovered as said oleaginous fraction, a sediment phase containing substantially all the solutes, said aqueous phase being recovered to give essentially colloidal particles and substantially all the solutes, said aqueous phase being recovered to give an essentially colloidal aqueous substance, or if necessary, filtered to remove out any remaining finer undissolved solids to give said essentially colloidal aqueous substance; and separating said substance into two fractions by one or more membrane filtrations, giving as retentate, said colloidal fraction containing substantially all the colloidal particles and containing solutes substantially all of which molecules are above 10000 Daltons in molecular weight, and giving as permeate is substantially clear and containing solutes substantially all of which molecules are below 10000 Daltons in molecular weight. An improvement is disclosed herein whereby the step of the process involving centrifugation of the vegetation liquor is conducted at a temperature below 13 degrees Celsius and the usage of hollow fibre membrane filter enables better separation.

Alternatively, according to the present invention, a process for extraction of phytochemicals from vegetation liquor derived from oil-bearing fruit comprises obtaining an oleaginous fraction, a colloidal fraction and an aqueous fraction from said vegetation liquor by the steps of separating said vegetation liquor by one or more membrane filtrations into two parts, the retentate containing substantially all the oleaginous parts and substantially all the undissolved solids, said oleaginous retentate being filtered to remove substantially all the undissolved solids to give, as filtrate, said oleaginous fraction; and giving, as permeate, an aqueous fraction containing substantially all the colloidal particles and substantially all the solutes, this being an essentially colloidal aqueous substance; and separating said substance into two fractions by one or more membrane filtrations, giving as another retentate, said colloidal fraction containing substantially all the colloidal particles and containing solutes substantially all of which molecules are above 10000 Daltons in molecular weight, and giving as another permeate, being substantially clear and containing solutes substantially all of which molecules are below 10000 Daltons in molecular weight.

In addition, according to the present invention, a process for extraction of phytochemicals from vegetation liquor derived from oil-bearing fruit comprises obtaining an oleaginous fraction, a colloidal fraction and an aqueous fraction from said vegetation liquor by the steps of filtering from said vegetation liquor substantially all of the undissolved solids contained in said vegetation liquor, and separating the filtrate so obtained into two parts by one or more membrane filtrations, giving as permeate, an aqueous substance containing substantially all the colloidal particles and substantially all the solutes; and, as retentate, giving said oleaginous fraction containing substantially all the oleaginous parts; and separating the permeate so obtained into two parts by one or more membrane filtrations, giving as another retentate, said colloidal fraction containing substantially all the colloidal particles and containing solutes substantially all of which molecules are above 10000 Daltons in molecular weight, and giving as another permeate, being substantially clear and containing solutes substantially all of which molecules are below 10000 Daltons in molecular weight.

According to the present invention, an improvement to the processes as described in the preceding paragraphs is disclosed which comprises the additional step of removing from said aqueous fraction, being the substantially clear permeate obtained as an end result of the processes of the preceding paragraphs, some part of or substantially all the water content to give either a concentrated aqueous fraction or a residue. Another alternative according to the present invention is a process for extraction of phytochemicals from vegetation liquor derived from oil-bearing fruit which comprises obtaining a concentrated aqueous fraction or a residue from said vegetation liquor by the steps of separating said vegetation liquor into two parts by one or more membrane filtrations, which is further characterized as hollow fibre membrane filtration. The retentate containing substantially all the oleaginous parts, colloidal particles and undissolved solids; and giving as permeate, being substantially clear and containing solutes substantially all of which molecules are below 10000 Daltons in molecular weight and removing from said aqueous fraction some or substantially all the water content therein to give either said concentrated aqueous fraction or said residue. Furthermore, according to this invention, an oleaginous fraction is recoverable from the retentate obtained in the first membrane filtration carried out in the process as described above in this paragraph.

There are herein disclosed, according to the present invention, substances that are products of the invented 1 process as follows:
a) an aqueous fraction, being substantially clear and containing solutes substantially all of which molecules are below 10000 Daltons in molecular weight,
b) a concentrated aqueous fraction, being said aqueous fraction with some part of the water content removed,
c) a residue, being said aqueous fraction or said concentrated aqueous fraction with substantially all the water content removed,
d) an extract rich in hydroxy acids or phenolic acids or flavonoids or any combination thereof, and
e) a dried extract rich in hydroxy acids or phenolic acids or flavonoids or any combination thereof.

The last two substances, namely said extract or said dried 2 extract, according to the present invention, are obtained by a process which involves one or more steps of pH adjustment and solvent extraction upon either vegetation liquor derived from oil-bearing fruit or said aqueous fraction or said concentrated aqueous fraction or said residue reconstituted into an aqueous form.

There is herein disclosed, according to the present invention, a method of extracting phytochemicals by obtaining an aqueous fraction containing, among other phytochemicals, flavonoids, phenolic acids, hydroxy acids and shkimic acid or obtaining a concentrated aqueous fraction containing, and among other phytochemicals, flavonoids, phenolic acids, hydroxy acids, or obtaining a residue containing, among other phytochemicals, flavonoids, phenolic acids and hydroxy acids, or obtaining an extract rich in hydroxy acids or phenolic acids or flavonoids or any combination thereof, or obtaining a dried extract rich in hydroxy acids or phenolic acids or flavonoids or any combination thereof, through the application of the invented process to vegetation liquor derived from oil-bearing fruit.

According to the present invention, the invented substances disclosed may be used to make, or are contained in, drinks, edible products, tonics, health supplements, antioxidant additives, cosmetics, soaps, shampoos, detergents, drugs or medicinal products. It is clear, according to this invention, that products may be produced using or containing, in any way, form or proportion, a fraction extracted from vegetation liquor derived from oil-bearing fruit, in particular from palm oil mill effluent or from concentrated palm oil mill effluent, said fraction having substantially no oleaginous parts, substantially no colloidal particles and substantially no undissolved solids, and said fraction containing, among other phytochemicals, flavonoids, phenolic acids, shkimic acid and hydroxy acids.

Low grade oil may be recovered for sale from the oleaginous fraction, and the colloidal fraction may be sold as animal feed, as animal food supplement or as substrate for microbial growth. The water from the invented process is substantially pure and is recyclable. The invention realises new products which will enhance effluent treatment economics. The invention further provides an apparatus, or a combination of devices, for extraction of phytochemicals from vegetation liquor derived from oil-bearing fruit characterised in that means are provided in said apparatus, or in said combination of devices, to perform the processes as described herein.

Specific embodiments of the invention will now be described by way of example only. While the embodiments here deal with vegetation liquor derived from oil palm, it is intended that the invention will find wider application to other sources of vegetation liquor derived from oil-bearing fruit.

As an example, vegetation liquor is derived from fifteen oil palm fruitlets by autoclaving at 120 degrees Celsius at a gauge pressure of 103421 Pascals (15 psig) for 15 minutes following addition of 5 millilitres of water. The liquor so derived is collected and filtered through a Whatman number 4 filter paper. The filtrate is then transferred into a Centriprep 10 (Amicon) system and is centrifuged to give a permeate containing solutes of molecular weight less than 10000 Daltons, this providing the aqueous fraction from the vegetation liquor, the presence of the phytochemicals being confirmed by analysis. A sample of the aqueous fraction is used to recover an extract containing hydroxy acids and phenolic acids and flavonoids by extracting with ethyl acetate, first at a neutral pH of 7 achieved by adding sodium hydroxide, and subsequently at a pH of 2 achieved by adding hydrochloric acid, the presence of the hydroxy acids and phenolic acids and flavonoids being confirmed by analysis.

The oleaginous fraction is found to comprise low grade crude palm oil with about a quarter of its content as free fatty acids. The colloidal fraction is found to be proteinaceous. The aqueous fraction is found to contain essential minerals (iron, phosphorus, calcium, magnesium), sugars (among which are glucose, fructose, sucrose), vitamins (among which are vitamin C, the B-complex vitamins, folic acid), flavonoids (among which are catechin, catechin gallate, epicatechin, epigallocatechin, epigallocatechin gallate, epicatechin gallate, quercetin), phenolic acids (among which are parahydroxy benzoic acids, caffeic acid, isomaers of caffeoy shikimic acid, protocatechuic acid, vanillic acid, ferulic acid, syringic acid, chlorogenic acid, gallic acid, tannic acid, coumaric acid) and hydroxy acids and organic acids (among which are citric acid, ascorbic acid, lactic acid, glycolic acid, fumaric acid, tartaric acid, salicyclic acid). Where the aqueous fraction is obtained using the membrane with the higher (30,000 Dalton) molecular weight cut-off, the solutes contain more proteins and other filtrates, which could reduce the purity depending on the eventual application. The residue obtained by freeze drying the aqueous fraction is found to contain an average of about 40,000 parts per million of phenolic compounds, and antioxidant activity is indicated. The extract is found to contain hydroxy acids (among which are citric acid, ascorbic acid, lactic acid, glycolic acid, fumaric acid, tartaric acid, salicyclic acid), phenolic acids (among which are para hydroxyl benzoic acid, isomers of caffeoyl shikimic acid, caffeic acid, protocatechuic acid, vanillic acid, ferulic acid, syringic acid, chlorogenic acid, gallic acid, tannic acid, coumaric acid) and flavonoids (among which are catechin, catechin gallate, epicatechin, epigallocatechin, epigallocatechin gallate, epicatechin gallate, quercetin). As a seventh example, fresh vegetation liquor is filtered to remove undissolved solids and the filtrate is subject to membrane filtration using the Membrex Ultrafilic system with a molecular weight cut-off of 100,000 Daltons. This gives the oleaginous fraction as retentate and, as permeate, gives an essentially colloidal aqueous substance which is subject to another membrane filtration with molecular weight cut-off of 10,000 Daltons. This gives the colloidal fraction as another retentate and, as another permeate, gives the aqueous fraction containing, among other phytochemicals, shikimic acid, flavonoids, phenolic acids and hydroxy acids. This aqueous fraction is concentrated or dried and the water so obtained is substantially pure.

The system for treatment of vegetation liquors as described herein can be in continuous and batch mode.

While examples of the invention have been described in detail, it should be apparent that many modifications and variations thereto are possible all of which fall within the true spirit and scope of the invention.

In the foregoing specification, specific embodiments of the present invention have been described. However, one of ordinary skill in the art will appreciate that various modifications and changes can be made without departing from the scope of the present invention as set forth in the various embodiments discussed above and the claims that follow. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements as described herein.

1. A process for extraction of phytochemicals from vegetation liquor derived from oil-bearing fruit comprising:
a) contacting said vegetation liquor with a material that preferentially adsorbs or absorbs oleaginous parts;
b) filtering said vegetation liquor to yield an oleaginous retentate and a colloidal aqueous solution; and
c) filtering said colloidal aqueous solution obtained from said vegetation liquor, with a hollow fibre filter, wherein said hollow fibre filter is configured to remove molecules above 10000 Daltons in molecular weight and allows molecules 10000 Daltons or less to pass through as aqueous permeate; wherein said aqueous permeate comprises phytochemical.

2. The process of claim 1, further comprising obtaining an oleaginous fraction and a colloidal fraction, prior to the hollow fibre filtration of said colloidal aqueous solution, by a process comprising steps of:
a) filtering said vegetation liquor to yield an oleaginous retentate having oleaginous parts and solids; and
b) filtering said oleaginous retentate to remove said solids and obtaining said oleaginous fraction as filtrate

3. The process of claim 1, further comprises obtaining an oleaginous fraction and a colloidal fraction, prior to the hollow fibre filtration, by a process having method steps of:
a) filtering said vegetation liquor to remove said solids, to yield an oleaginous fraction containing said oleaginous parts as retentate, and an aqueous fraction having colloidal particles and solutes as permeate;
b) filtering said aqueous fraction to yield a colloidal fraction as retentate that comprises colloidal particles and solutes with molecular weight above 10000 Daltons.

4. The process of claim 1, wherein said vegetation liquor is derived from milling palm oil.

5. The process of claim 1, further comprising removing water content from said aqueous fraction to give a concentrated aqueous fraction, or a residue.

6. The process of claim 1, wherein said vegetation liquor is derived from one or more sources selected from a group consisting of oil palm fruitlets, oil palm fruit bunch, hot sterilizer condensate collected immediately on discharge from the sterilizers at a palm oil mill, and discharge from the sludge centrifuge at a palm oil mill.

7. The process of claim 6, wherein said sterilizer is horizontal sterilizer.

8. The method of claim 1, wherein said aqueous permeate is free of oleaginous parts, colloidal substances, and solids.

9. The process of claim 1, wherein said membrane filter is configured to remove molecules above 10000 Daltons in molecular weight.

10. An aqueous fraction containing phytochemicals obtained by the process of claim 1.

11. The aqueous fraction of claim 10, which has been concentrated by removing water content.

12. A residue containing phytochemicals produced by removing all of the water content from said aqueous fraction obtained by said process of claim 1.

13. A process for extraction of phytochemicals from vegetation liquor derived from palm fruit comprising:
a) centrifuging said vegetation liquor to give a light phase, a sediment phase and an aqueous phase,
b) recovering said aqueous phase; and
c) filtering said aqueous phase with a hollow fibre filter, wherein said membrane filter is configured to remove molecules above 10000 Daltons in molecular weight to yield an aqueous permeate comprising phytochemicals.

14. The process of claim 13, wherein said step of recovering the aqueous phase further comprising the step of filtering said aqueous phase with a stainless steel filter.
